(19) United States
(12) Patent Application Publication
(10) Pub. No.: US 2012/0110859 A1
(43) Pub. Date: May 10, 2012

(54) ELECTRIC HAIR TRIMMER

(76) Inventor: Carl G. Kammer, Middleton, WI (US)

(21) Appl. No.: 12/942,147

(22) Filed: Nov. 9, 2010

(51) Int. Cl. B26B 19/10; B26B 19/02; B26B 19/04

(52) U.S. Cl. 30/223; 30/233; 30/225

(57) ABSTRACT

An electric hair trimmer generally includes a handle housing a drive motor and a cutter head releasably connectable to the handle. The cutter head includes a housing having an interior compartment, and a cutting assembly including a pair of cutting blades. At least one of the cutting blades is in operative connection with the drive motor upon connection of the cutter head with the handle for reciprocating movement of the at least one of the blades. At least a portion of the cutting assembly is disposed within the housing, and the cutting assembly further has a front edge disposed exterior of the housing for trimming hair upon operation of the trimmer. The housing has a plurality of guard fingers at least in part wrapped over the front edge of the cutting assembly to inhibit the front edge against contacting a person's skin during hair trimming.

### BACKGROUND

The present invention relates generally to electric hair trimmers and, more particularly, to a cutter head for an electric hair trimmer.

Conventional electric hair trimmers typically include a stationary cutting blade and a movable (reciprocating or oscillating) cutting blade that are arranged in sliding, face-to-face contact with one another. In operation, the reciprocating blade is driven back and forth relative to the stationary blade as the trimmer is moved over the skin in an area to be trimmed, such that hair entering the teeth of the blades is trimmed. With such an arrangement, the trimmer can be used to trim hair to any desired length. However, when a shorter hair length is desired, the blades are often used in close proximity to the skin and may contact the skin, which can result in the blades cutting or otherwise irritating the skin.

There is a need, therefore, for an electric hair trimmer that inhibits skin from being cut or otherwise irritated by the blades of the trimmer.

### SUMMARY OF THE INVENTION

In one embodiment, an electric hair trimmer generally includes a handle housing a drive motor and a cutter head releasably connectable to the handle. The cutter head comprises a housing having an interior compartment, and a cutting assembly comprising a pair of cutting blades. At least one of the cutting blades is in operative connection with the drive motor upon connection of the cutter head with the handle for reciprocating movement of the at least one of the blades. At least a portion of the cutting assembly is disposed within the housing, and the cutting assembly further has a front edge disposed exterior of the housing for trimming hair upon operation of the trimmer. The housing has a plurality of guard fingers at least in part wrapped over the front edge of the cutting assembly to inhibit the front edge against contacting a person's skin during hair trimming.

In another embodiment, a cutter head for an electric hair trimmer generally includes a housing having an interior compartment, and a cutting assembly comprising a pair of cutting blades. At least one of the cutting blades is configured for reciprocating movement, and at least a portion of the cutting assembly is disposed within the housing. The cutting assembly further has a front edge disposed exterior of the housing for trimming hair upon operation of the trimmer, and the housing has a plurality of guard fingers at least in part wrapped over the front edge of the cutting assembly to inhibit the front edge against contacting a person's skin during hair trimming.

In yet another embodiment, an electric hair trimmer generally includes a handle housing a drive motor and a cutter head releasably connectable to the handle. The cutter head includes a housing having an interior compartment, and a cutting assembly comprising a pair of cutting blades. At least one of the cutting blades is in operative connection with the drive motor upon connection of the cutter head with the handle for reciprocating movement of said at least one of the blades. At least a portion of the cutting assembly is disposed within the housing, and the cutting assembly further has a front edge disposed exterior of the housing for trimming hair upon operation of the trimmer. The housing has a cutter guard extending over a portion of the front edge of the cutting assembly to inhibit the front edge against contacting a person's skin during hair trimming.

In yet another embodiment, a cutter head for an electric trimmer generally includes a housing having an interior compartment and a cutting assembly having a pair of cutting blades. At least one of the cutting blades is in operative connection with the drive motor upon connection of the cutter head with the handle for reciprocating movement of said at least one of the blades. At least a portion of the cutting assembly is disposed within the housing, and the cutting assembly further has a front edge disposed exterior of the housing for trimming hair upon operation of the trimmer. The housing includes a plurality of guard fingers extending beyond but not over the front edge of the cutting assembly to inhibit the front edge against contacting a person's skin during hair trimming.

In yet another embodiment, a cutter head for an electric trimmer generally includes a housing having an interior compartment and a cutting assembly having a pair of cutting blades. At least one of the cutting blades is in operative connection with the drive motor upon connection of the cutter head with the handle for reciprocating movement of said at least one of the blades. At least a portion of the cutting assembly is disposed within the housing, and the cutting assembly further has a front edge disposed exterior of the housing for trimming hair upon operation of the trimmer. The housing includes a plurality of acruately shaped guard fingers wrapped over the front edge of the cutting assembly to inhibit the front edge against contacting a person's skin during hair trimming.

In yet another embodiment, a cutter head for an electric trimmer generally includes a stationary blade having a plurality of guard fingers and a movable blade having a plurality of teeth. The movable blade is biased in face-to-face contact with the stationary blade such that the teeth are slidable against the stationary blade with the plurality of guard fingers of said stationary blade wrapped over at least a portion of the teeth of said movable blade to inhibit said teeth against contacting a person's skin during hair trimming.

### BRIEF DESCRIPTION OF THE DRAWINGS

FIG. 1 is a perspective view of one embodiment of an electric hair trimmer;

FIG. 2 is perspective view of a handle of the electric hair trimmer of FIG. 1;

FIG. 3 is a perspective view of a head of the electric hair trimmer of FIG. 1;

FIG. 4 is a bottom plan view thereof;

FIG. 5 is an exploded view thereof;

FIG. 6 is a front elevation of a lower shell of the head of FIG. 3;

FIG. 7 is a side elevation thereof;

FIG. 8 is an enlarged portion of the lower shell of FIG. 7;

FIG. 9 is a front elevation of an upper shell of the head of FIG. 3;

FIG. 10 is a cross-section taken in the plane of line 10-10 of FIG. 9;

FIG. 11 is an enlarged portion of the upper shell of FIG. 10;

FIG. 12 is a perspective view of a second embodiment of a head of the electric trimmer of FIG. 1;

FIG. 13 is an exploded view thereof;

FIG. 14 is a front elevation thereof;

FIG. 15 is a cross-section taken in the plane of line 15-15 of FIG. 14;

FIG. 16 is an enlarged portion of the head of FIG. 15;

FIG. 17 is a perspective view of a third embodiment of a head of the electric trimmer of FIG. 1;

FIG. 18 is an exploded view thereof;

FIG. 19 is a front elevation thereof;

FIG. 20 is a cross-section taken in the plane of line 20-20 of FIG. 19;

FIG. 21 is an enlarged portion of the head of FIG. 20;

FIG. 22 is a perspective view of a fourth embodiment of a head of the electric trimmer of FIG. 1;

FIG. 23 is an exploded view thereof;

FIG. 24 is a front elevation thereof;

FIG. 25 is a cross-section taken in the plane of line 25-25 of FIG. 24;

FIG. 26 is an enlarged portion of the head of FIG. 25;

FIG. 27 is a perspective view of a fifth embodiment of a head of the electric trimmer of FIG. 1;

FIG. 28 is an exploded view thereof;

FIG. 29 is a front elevation thereof;

FIG. 30 is a cross-section taken in the plane of line 30-30 of FIG. 29;

FIG. 31 is an enlarged portion of the head of FIG. 30;

FIG. 32 is a perspective view of a sixth embodiment of a head of the electric trimmer of FIG. 1;

FIG. 33 is an exploded view thereof;

FIG. 34 is a front elevation thereof;

FIG. 35 is a cross-section taken in the plane of line 35-35 of FIG. 34; and

FIG. 36 is an enlarged portion of the head of FIG. 35.

Corresponding reference characters indicate corresponding parts throughout the several views of the drawings.

### DETAILED DESCRIPTION OF THE PREFERRED EMBODIMENTS

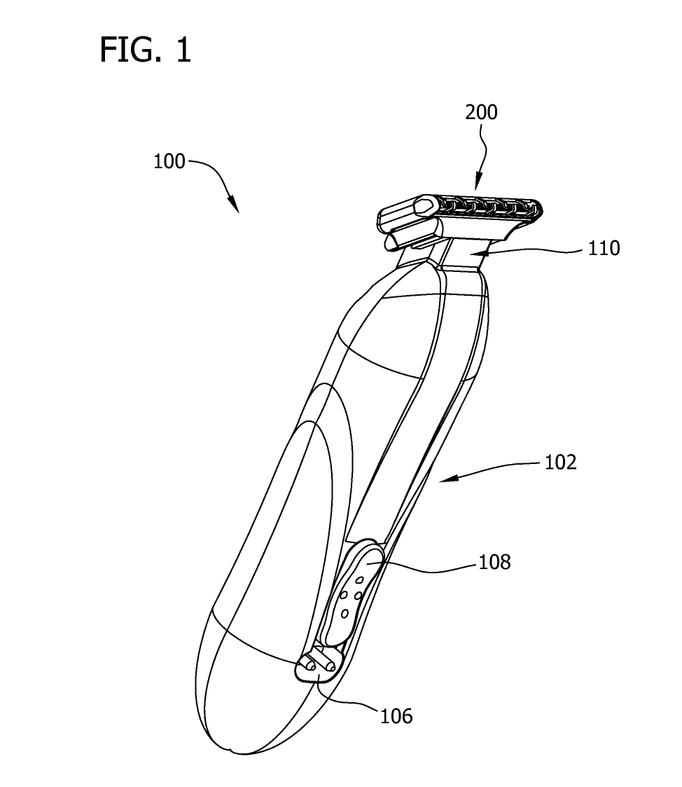

Referring now to the drawings, and in particular to FIG. 1, an electric hair trimmer according to one embodiment is indicated generally by the reference numeral 100 and is illustrated in the form of a surgical clipper used for trimming the hair of patients prior to surgery. It is understood, however, that embodiments of the hair trimmer may also be used for trimming facial hair (e.g., a moustache or beard), for trimming the hair on one's head, or for any other suitable purpose without departing from the scope of this invention. The illustrated electric hair trimmer 100 comprises a handle, generally indicated at 102, and a cutter head, generally indicated at 200, releasably connected to the handle 102. While not illustrated in the drawings, the handle 102 houses a suitable rechargeable battery, a motor, and associated electronics (e.g., circuitry), all of which are known to those skilled in the art for operating the trimmer. Accessible by a user on an exterior of the handle 102 are an electrical socket 106 for charging the battery, a user interface (e.g., a power switch 108) for operating the trimmer, and a neck 110 at which the cutter head 200 releasably connects to the handle 102.

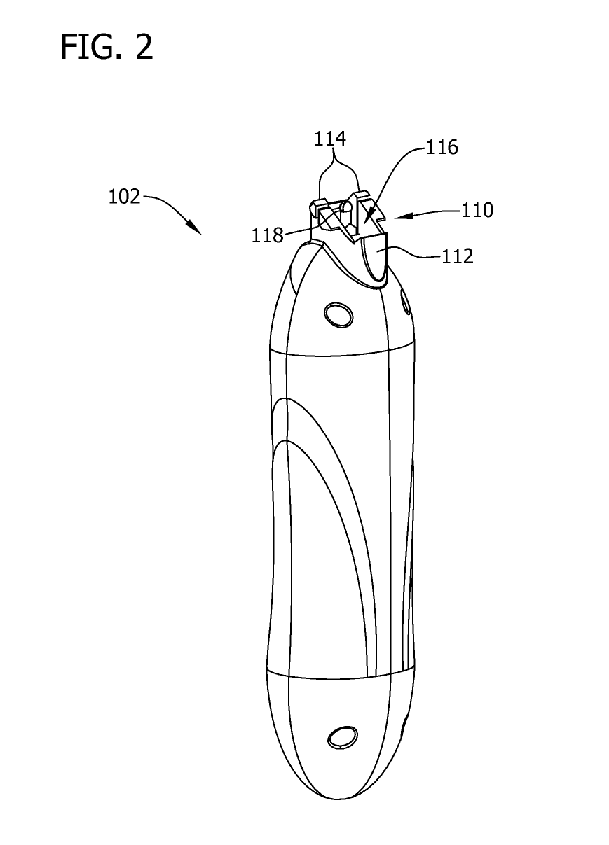

With reference to FIG. 2, the illustrated neck 110 comprises a peripheral side wall 112 and a pair of opposing connection tabs 114 that extend transversely outward from the peripheral side wall 112. The peripheral side wall 112 defines a pocket 116 in which a drive pin 118 (e.g., an eccentric drive pin or an oscillating drive pin) is disposed. The drive pin 118 is operatively connected to a drive shaft (not shown) of the motor and is configured for operative connection with the cutter head 200. It is understood, however, that the cutter head may be releasably connectable to the housing in another suitable manner, and/or it may be operatively connected to the motor in another suitable manner, without departing from the scope of this invention.

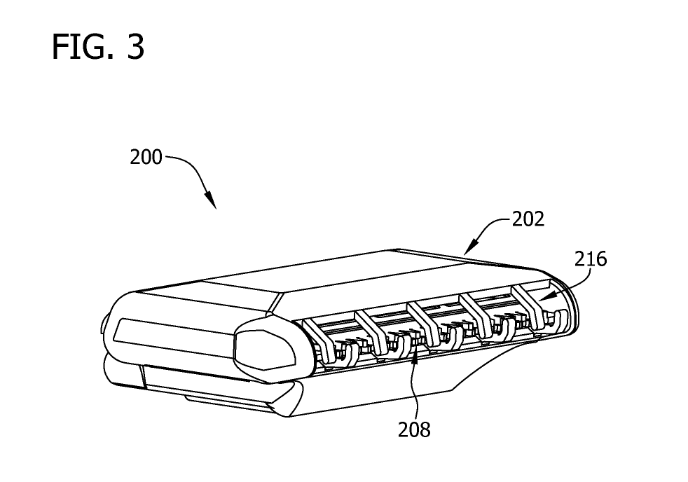

As illustrated in FIGS. 3-5, the cutter head 200 according to one embodiment suitably comprises a two-piece housing 202 including a lower shell 204 and an upper shell 206 that are configured for assembly with each other to house a cutting assembly 208 in an interior compartment of the head 200. The lower and upper shells 204, 206 are configured to define an elongate opening or slot 216 in the assembled housing 202 from which a front edge 218 of the cutting assembly 208 extends for trimming hair. The cutting assembly 208 comprises a stationary blade 210 and a movable or reciprocating blade 212 that is biased against the stationary blade 210 via a suitable biasing member (e.g., a spring plate 214) such that the movable blade 212 remains in sliding, face-to-face contact with the stationary blade 210 during operation. The teeth of each of the blades 210, 212 extend outward through the opening 216 of the housing 202 to collectively define the front edge 218 of the cutting assembly 208.

The cutting assembly 208 also comprises a base 215 that extends downward from the stationary blade 210 such that a follower 217, which is operatively connected to the movable blade 212, is accessible for oscillating the movable blade 212. In other embodiments, the cutting assembly 208 may have any suitable components arranged in any suitable manner that enables the cutter head 200 to function as described herein.

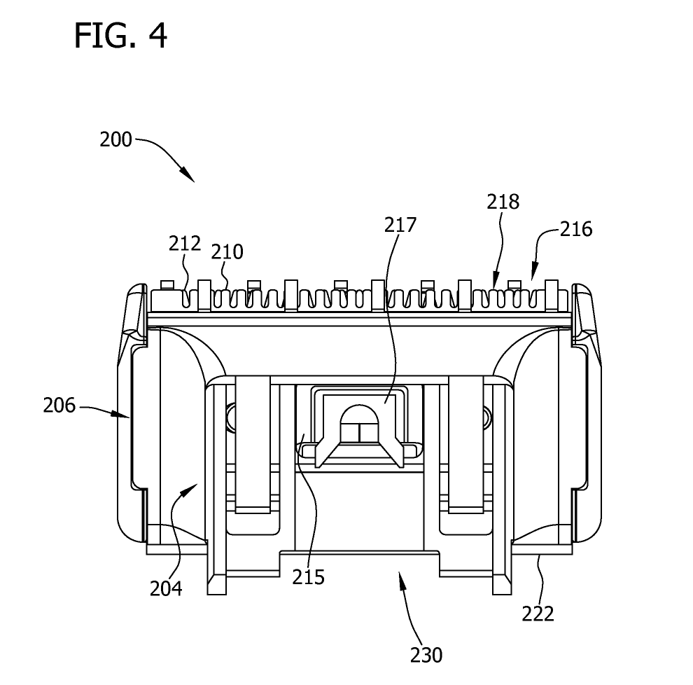

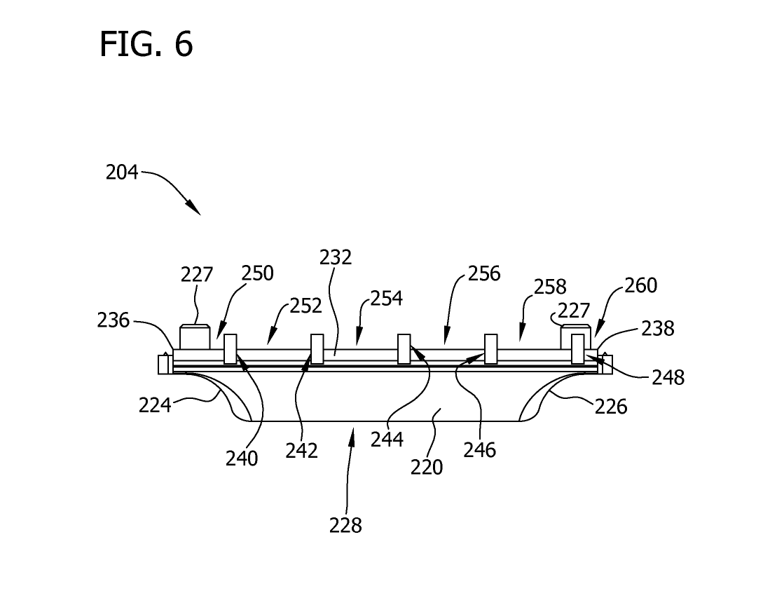

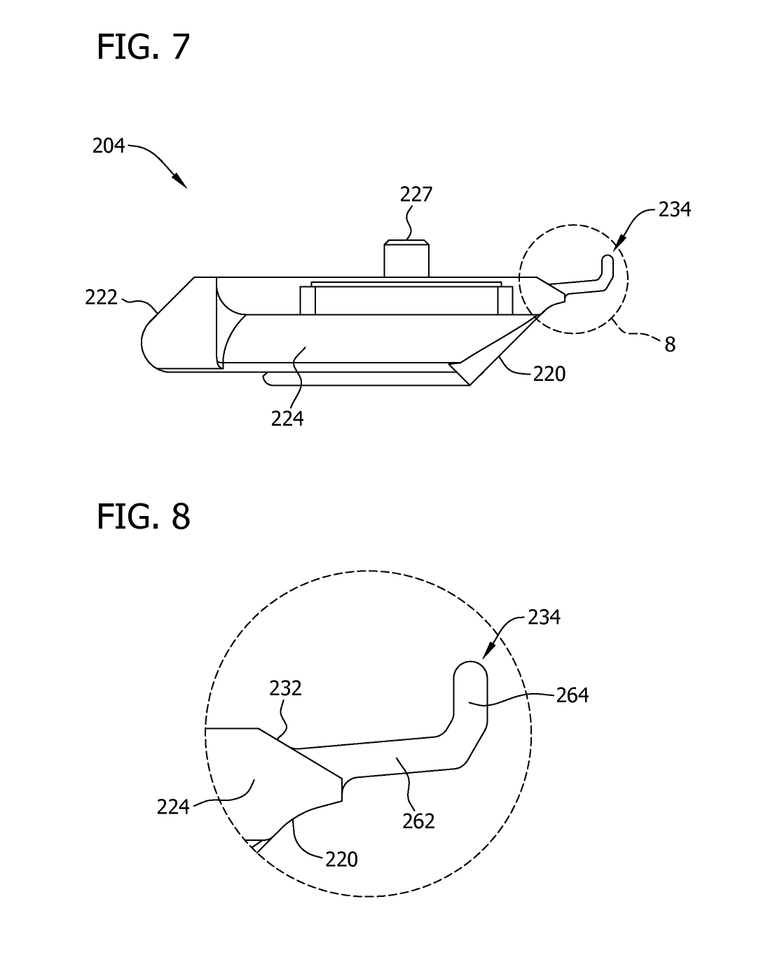

With reference to FIGS. 6-8, the lower shell 204 of the cutter head housing 202 is configured to have a front wall 220, a back wall 222 opposite the front wall, and opposite end walls 224, 226 extending between and interconnecting the front and back walls. A pair of interior bosses 227 are arranged on the lower shell 204 to facilitate locating and retaining the cutting assembly 208 within the interior compartment of the housing 202 upon assembly thereof. The lower shell 204 also has an open bottom 228 that defines an inlet 230 (FIG. 4) in the back wall 222 into which the neck 110 of the handle 102 is slidably insertable for releasable connection of the cutter head 200 to the handle 102 (e.g., via a pair of slots (not shown) into which the connection tabs 114 are inserted).

The front wall 220 comprises a front surface 232 including a portion of the elongate opening 216 in the cutter head housing 202, and a plurality of lower guard fingers 234 (at least in part broadly defining a cutter guard) extending outward from the front surface in spaced relationship along the length of the elongate opening. In the illustrated embodiment, the guard fingers 234 comprise a first finger 240, a second finger 242, a third finger 244, a fourth finger 246, and a fifth finger 248. The first finger 240 is suitably spaced apart from one end 236 of the elongate opening 216 by a first spacing 250, the second finger 242 is spaced apart from the first finger 240 by a second spacing 252, and the third finger 244 is spaced apart from the second finger 242 by a third spacing 254. Likewise, the fourth finger 246 is spaced apart from the third finger 244 by a fourth spacing 256, the fifth finger 248 is spaced apart from the fourth finger 246 by a fifth spacing 258, and the fifth finger 248 is spaced apart from the opposite end 238 of the elongate opening 216 by a sixth space 260. The second, third, fourth and fifth spacings 252, 254, 256, 258 of the illustrated lower shell are substantially equal, while the first and sixth spacings 250, 260 are less than the other spacings. Additionally, the first spacing 250 is greater than the sixth spacing 260.

It is understood that the lower shell 204 may comprise any number of guard fingers 234 other than five without departing from the scope of this invention. It is also understood that the spacings between adjacent guard fingers 234 may be other than as illustrated herein and remain with the scope of this invention.

Each of the guard fingers 234 of the lower shell 204 extends from a proximal end formed integral with the lower shell housing to a distal end, and includes a first segment 262 that projects from the proximal end outward (forward) from the front surface 232 of the shell, and a second segment 264 that extends from the first segment 262 to the distal end of the finger at an oblique angle relative to the first segment. For example, in the illustrated embodiment, the second segment 264 is angled upward from the first segment 262 at a generally perpendicular angle relative thereto such that the guard finger 234 is generally L-shaped. It is understood, however, that the second segment 264 may be angled other than generally perpendicular to the first segment 262 without departing from the scope of this invention, as long as it angles upward relative thereto.

In a particularly suitable embodiment, each guard finger 234 is configured to extend outward from the lower shell front surface 232 and then upward over the front edge 218 of the cutting assembly 208 as defined by the cutting blades 210, 212. For example, in the illustrated embodiment the first segment 262 of each guard finger 234 of the lower shell 204 is sized in length to extend outward beneath the cutting assembly 208 generally at least to and in some instances slightly beyond the front edge 218 of the cutting assembly. The second segment 264 is angled relative to the first segment 262 to extend at least in part upward therefrom generally over the front of the front edge 218 of the cutting assembly 208 and in the illustrated embodiment it extends up above the front edge of the cutting assembly.

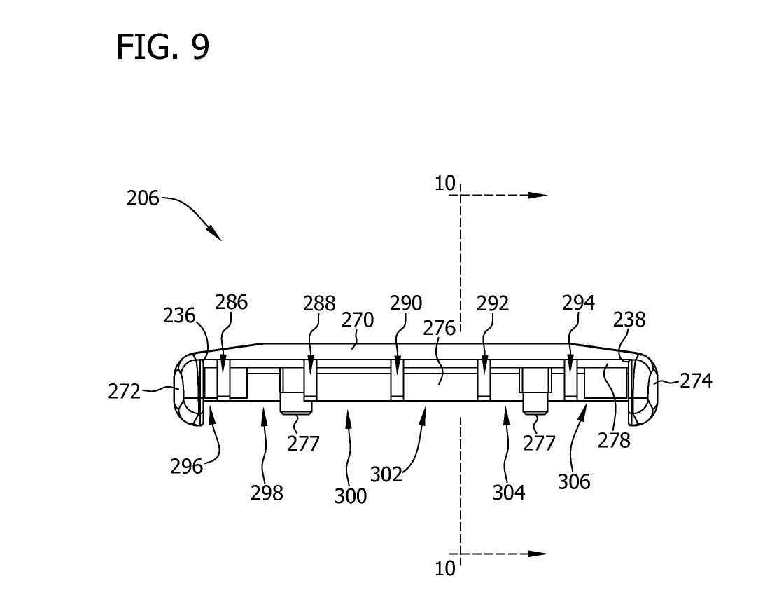

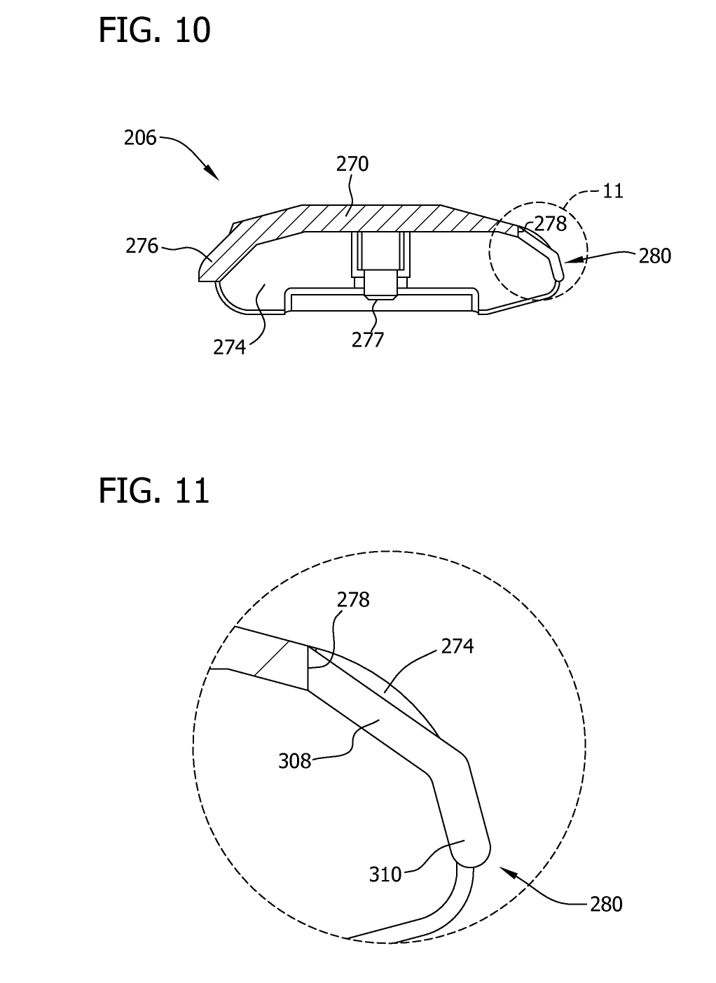

With reference now to FIGS. 9-11, the upper shell 206 comprises a top wall 270, opposite first and second end walls 272, 274 extending downward from the top wall, and a back wall 276 extending downward from the top wall between and interconnecting the end walls. A pair of interior bosses 277 are arranged on the upper shell 206 to facilitate locating and retaining the cutting assembly 208 within the interior compartment of the housing 202 upon assembly of the cutter head 200. At least a portion of the front of the upper shell 206 is open to together with the front of the lower shell 204 define the elongate opening 216 of the cutter head housing 202 through which the cutting assembly 208 extends out from the housing.

A plurality of upper guard fingers 280 (at least in part broadly defining the cutter guard) extend outward (e.g., forward) from a front surface 278 in spaced apart relationship with each other along the elongate opening 216 of the cutter head housing 202. In the illustrated embodiment, the guard fingers 280 comprise a first finger 286, a second finger 288, a third finger 290, a fourth finger 292, and a fifth finger 294. The first finger 286 is spaced from one end 236 of the elongate opening 216 by a first spacing 296, the second finger 288 is spaced from the first finger 286 by a second spacing 298, and the third finger 290 is spaced from the second finger 288 by a third spacing 300. Likewise, the fourth finger 292 is spaced from the third finger 290 by a fourth spacing 302, the fifth finger 294 is spaced from the fourth finger 292 by a fifth spacing 304, and the fifth finger 294 is spaced from the opposite end 238 of the elongate opening 216 by a sixth spacing 306. The second, third, fourth and fifth spacings 298, 300, 302, 304 are substantially equal, while the first and sixth spacings 296, 306 are smaller than the other spacings. Additionally, the first spacing 296 is smaller than the sixth spacing 306. The arrangement and spacing of the guard fingers 286, 288, 290, 292, 294 of the upper shell 206 suitably permits an intersticed alignment with the guard fingers 240, 242, 244 246, 248 of the lower shell 204 upon assembly of the cutter head 200.

It is understood that the upper shell 206 may comprise any number of guard fingers 280 other than five without departing from the scope of this invention. It is also understood that the spacings between adjacent guard fingers 280 may be other than as illustrated herein and remain with the scope of this invention.

Each of the guard fingers 280 of the upper shell 206 extends from a proximal end formed integral with the upper shell housing to a distal end, and includes a first segment 308 that projects from the proximal end outward (forward) from the front surface 278 of the shell, and a second segment 310 that extends from the first segment to the distal end of the finger at an oblique angle relative to the first segment. For example, in the illustrated embodiment, the first segment 308 extends outward and downward (i.e., at least in part forward) from the front surface 278 of the upper shell 206 at an angle relative thereto. The second segment 310 is angled further downward (i.e., at least in part downward) from the first segment 308 at an angle greater than perpendicular. It is understood, however, that the second segment 310 may be angled other than as illustrated relative to the first segment 308 without departing from the scope of this invention, as long as it angles in part downward relative thereto.

In a particularly suitable embodiment, each guard finger 280 is configured to extend at least in part outward from the upper shell front surface 278 and then downward over the front edge 218 of the cutting assembly 208 as defined by the cutting blades 210, 212. For example, in the illustrated embodiment the first segment 308 of each guard finger 280 of the upper shell 206 is sized in length to extend outward above the cutting assembly 208 generally at least to and in some instances slightly beyond the front edge 218 of the cutting assembly 208. The second segment 310 is angled relative to the first segment 308 to extend at least in part downward therefrom generally over the front of the front edge 218 of the cutting assembly 208 and in the illustrated embodiment it extends down below the front edge of the cutting assembly.

To assemble the cutter head 200, the cutting assembly is located (e.g., using the respective bosses on one of the upper and lower shells 204, 206) on either the upper or the lower shell. The upper shell 206 is then connected to the lower shell 204 via any suitable connection (e.g., via a snap-fit connection, an adhesive, thermal bonding and/or welded connection, and/or a mechanical fastener connection) such that the shells 204, 206 house the cutting assembly 208 in the interior compartment of the cutter head 200. The first end wall 224 of the lower shell 204 abuts the first end wall 272 of the upper shell 206, the second end wall 226 of the lower shell 204 abuts the second end wall 274 of the upper shell 206, and the back wall 222 of the lower shell 204 abuts the back wall 276 of the upper shell 206 to substantially enclose the cutting assembly 208 within the cutter head housing 202 except for the portion that extends outward from the elongate opening 216 of the housing. The bosses 227, 277 suitably locate and retain (e.g., maintain the orientation and position of) the cutting assembly 208 within the housing 202. It is understood that the cutter housing 202 may be other than of two piece construction, such as a single piece or more than two pieces, without departing from the scope of this invention.

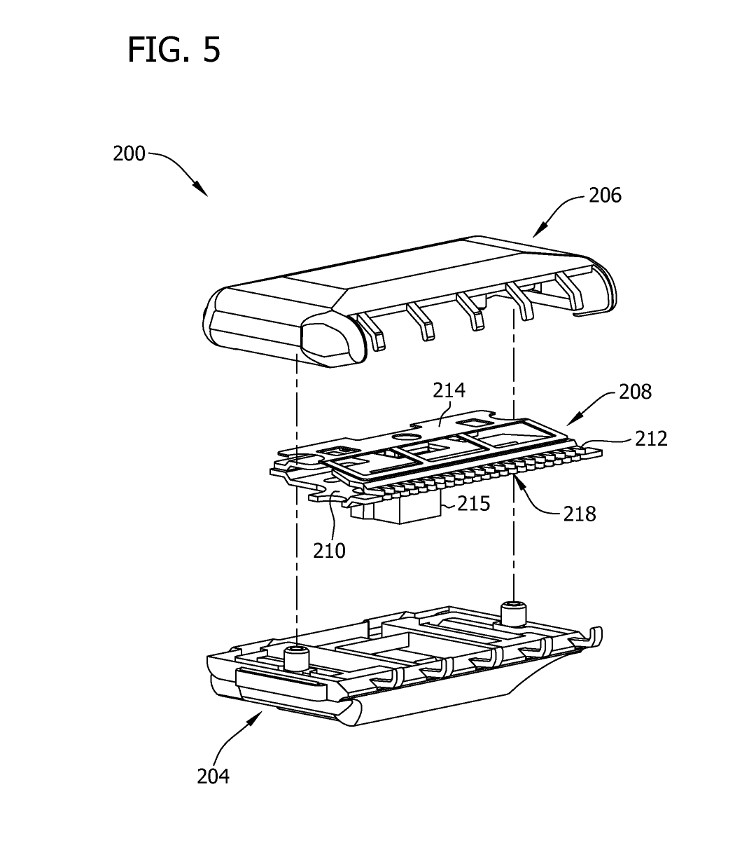

When the upper shell 206 is connected to the lower shell 204, the guard fingers 280 of the upper shell are intersticed with the guard fingers 234 of the lower shell. The guard fingers 280 may be arranged for generally equal spacing from the guard fingers 234 as in the illustrated embodiment of FIG. 5, or they may be arranged to be other than generally equally spaced from the guard fingers of the lower shell, such as in closely spaced relationship with the guard fingers of the lower shell or otherwise closer to one lower shell guard finger than another.

With the upper and lower guard fingers 280, 234 arranged in this manner, the stationary and movable cutting blades 210, 212 extend outward from the housing 202 through the opening 216 such that the front edge 218 is exterior of the housing 202 (e.g., outward beyond the front surfaces 232, 278 at the elongate opening of the housing). The respective second segments of the upper guard fingers 280 and lower guard fingers 234 extend over (e.g., downward or upward) the front edge 218 defined by the blades 210, 212. As such, the front edge 218 is at least partially wrapped by the upper and lower guard fingers 280, 234. In operation, such an arrangement provides a small spacing of the front edge 218 from the skin in the area of hair trimming to inhibit skin from being cut by the cutting assembly 208 during trimming. In other embodiments, the cutter head 200 may include only the upper guard fingers 280 or only the lower guard fingers 234 without departing from the scope of this invention. It is also contemplated that a suitable cutter guard that extends over the front edge 218 of the housing may be configured other than in the form of guard fingers, such as a slotted panel or other suitable structure, without departing from the scope of this invention.

When the cutting assembly 208 is held within the housing 202, the base 215 of the cutting assembly 208 is accessible through the open bottom 228 of the lower shell 204, for operative connection with the drive pin 118. The assembled cutter head 200 is releasably connected to the neck 110 of the handle by sliding the neck 110 (e.g., the tabs 114) into the inlet 230 of the open bottom 228 of the cutter head housing such that the drive pin 118 is inserted into the follower 217. With the drive pin 118 inserted into the follower 217, the follower 217 and hence the movable blade 212 can be reciprocated via operation of the motor.

In the illustrated embodiment, when the assembled head 200 is connected to the handle 102, the only portion of the cutting assembly 208 that is exterior of the housing 202 is the portion of the cutting assembly 208 that is disposed between the fingers 234, 280 through the opening 216 (e.g., segments of the stationary and movable blades 210, 212). As such, the head 200 can be easily disconnected from the handle 102 by grasping handle 102 with one hand and grasping the housing 202 with the other hand to disconnect (e.g., slide or snap) the neck 110 out of the inlet 230 and away from the head 200, thereby enabling a user to replace the head 200 (e.g., to dispose of a used head and attach an unused head) without touching the cutting assembly 208.

In the illustrated embodiment, the head 200 is suitably fabricated from materials such that the entire cutter head is disposable after use (e.g., the head 200 can be a disposable head for use on a surgical trimmer). In other embodiments, the cutter head 200 may be fabricated from materials that are suitable for long-term, repeated use, such that the head is not intended to be disposable. It is also contemplated that the head 200 may have any suitable connection with the handle 102 such that the head 200 can be disconnected from the handle 102 in any suitable manner without departing from the scope of this invention. Additionally, it is contemplated that the head 200 may be configured such that the head 200 is intended to be permanently attached to the handle 102 during the life of the electric hair trimmer 100 and is not intended to be disconnected from the handle 102.

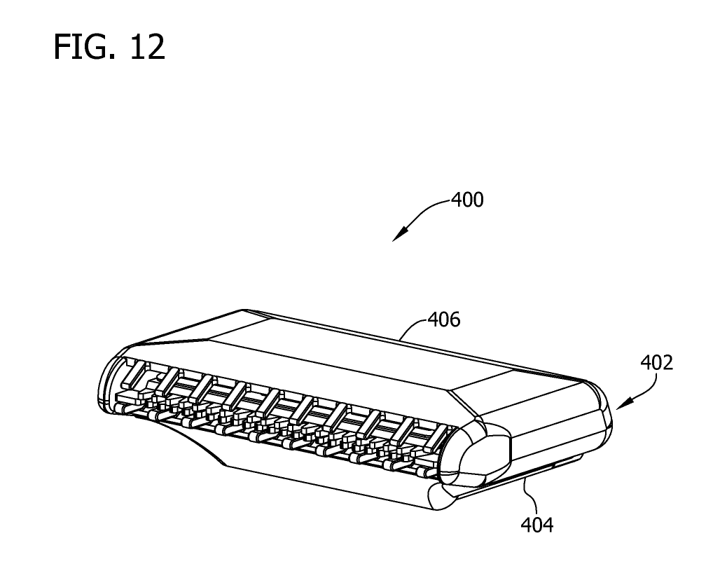

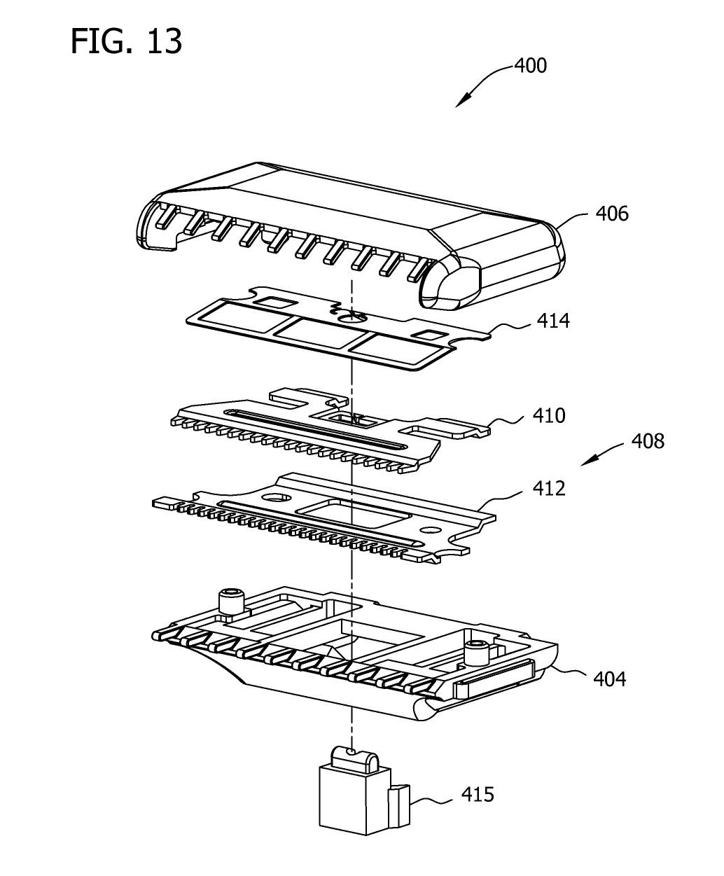

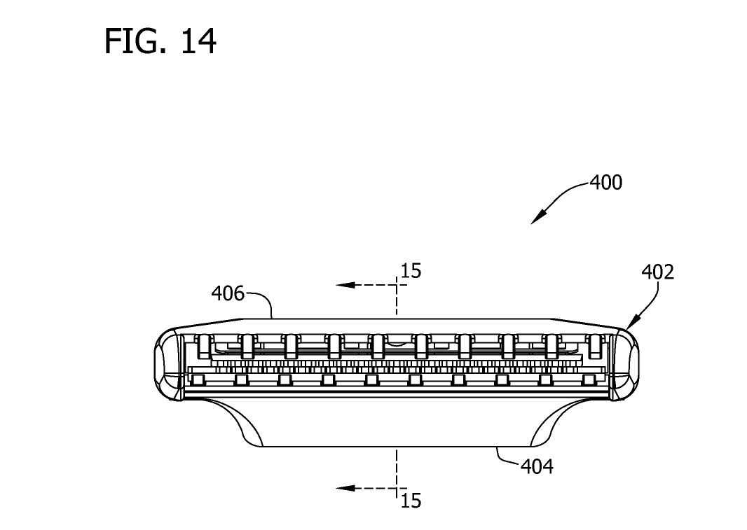

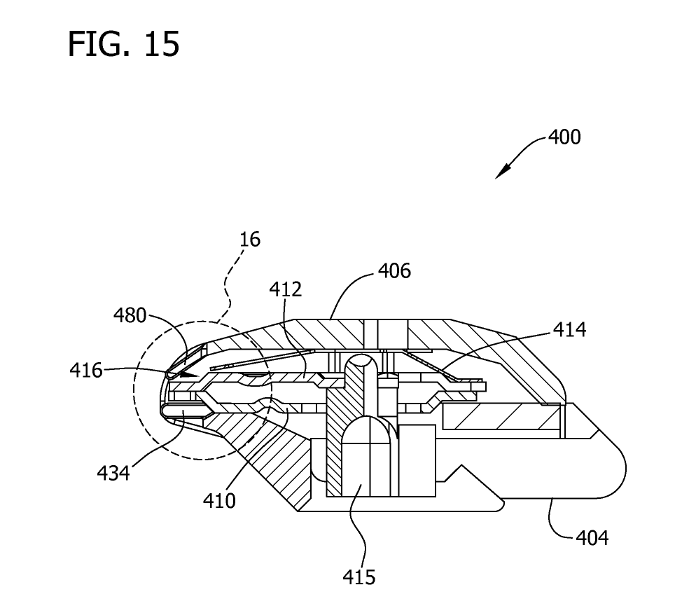

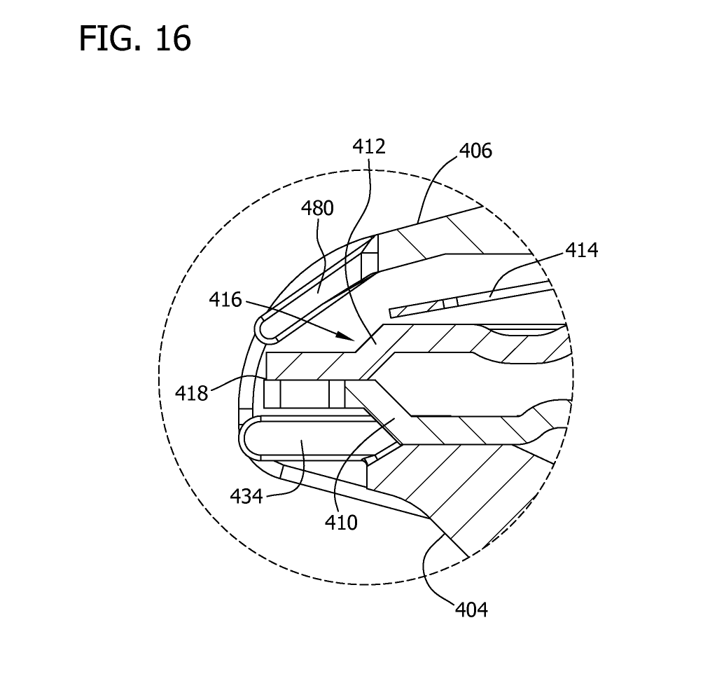

FIGS. 12-16 illustrate a second embodiment of a cutter head, generally indicated at 400, that is similar to the cutter head 200 of FIGS. 1-11. The cutter head 400 comprises a housing 402 having a lower shell 404 and an upper shell 406. The shells 404, 406 house a cutting assembly 408 and define an elongate opening 416 from which a front edge 418 of the cutting assembly 408 extends for trimming hair. The cutting assembly 408 comprises a stationary blade 410 and a movable blade 412 that is biased in sliding, face-to-face contact against the stationary blade 410 via a suitable biasing member (e.g., a spring plate 414). The teeth of each of the blades 410, 412 extend outward through the opening 416 of the housing 402 to collectively define the front edge 418 of the cutting assembly 408. The cutting assembly 408 also comprises a base 415 that extends downward from the stationary blade 410 to facilitate releasable and operable connection of the cutter head 400 to the handle 102 in a manner similar to that described above with respect to the cutter head 200.

The lower shell 404 comprises a plurality of lower guard fingers 434 extending outward in a spaced apart relationship along the length of the elongate opening 416. Each guard finger 434 extends, at an angle that is substantially parallel to the blades 410, 412, from a proximal end formed integral with the lower shell 404 to a distal end that is slightly beyond the front edge 418. Unlike the lower guard fingers 234 of the lower shell 204, the lower guard fingers 434 of the lower shell 404 do not extend generally over the front edge 418 of the cutting assembly 408. Similarly, the illustrated upper shell 406 comprises a plurality of upper guard fingers 480 that extend from a proximal end formed integral with the upper shell 406 to a distal end that is slightly beyond the front edge 418 at an oblique angle relative to the blades 410, 412 such that the guard fingers 480 extend in a spaced apart relationship along the elongate opening 416. Unlike the upper guard fingers 280 of the upper shell 206, the upper guard fingers 480 of the upper shell 406 do not extend generally over the front edge 418 of the cutting assembly 408.

Suitably, the illustrated lower guard fingers 434 and upper guard fingers 480 have an overall shape that is linear (i.e., is not bent). However, it is understood that the lower and upper shells 404, 406 may comprise any suitable number of guard fingers 434, 480 oriented at any suitable angle relative to blades 410, 412 and having any suitable overall shape without departing from the scope of this invention. It is also understood that the spacing between adjacent guard fingers 434, 480 may be other than as illustrated herein and remain with the scope of this invention.

In an assembled configuration of the cutter head 400 (FIG. 12), the arrangement of the guard fingers 480 of the upper shell 406, in combination with the arrangement of the guard fingers 434 of the lower shell 404, permits an intersticed alignment of the upper and lower guard fingers. Additionally, because the guard fingers 434, 480 extend slightly beyond, but not over, the front edge 418, the guard fingers 434, 480 enable a user to locate the front edge 418 of the cutting assembly 408 in closer proximity to the skin (i.e., enable the user to trim hair to a shorter length) while still inhibiting skin from contacting the front edge 418.

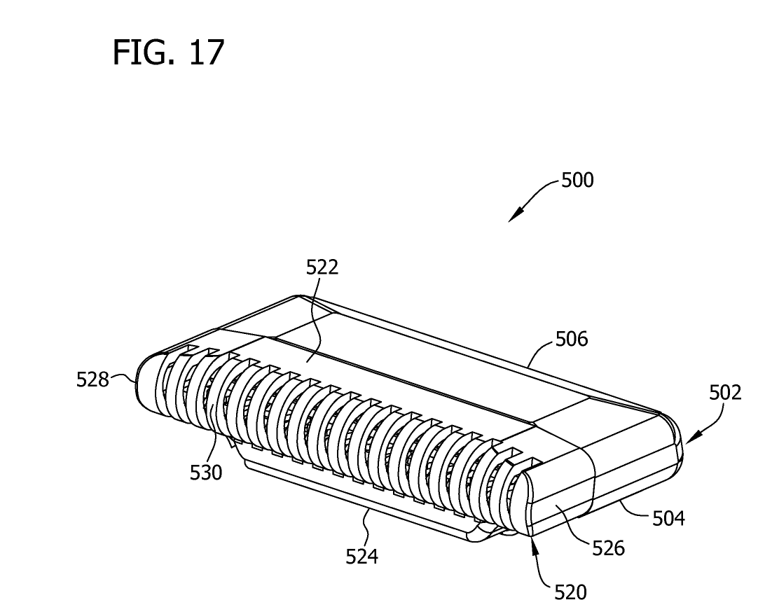

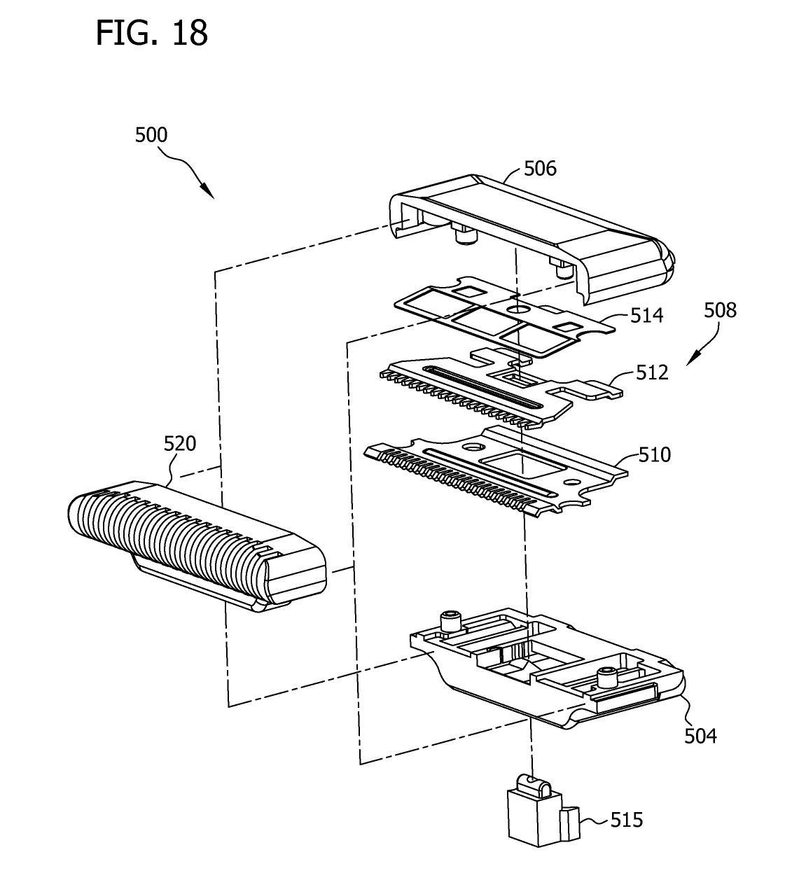

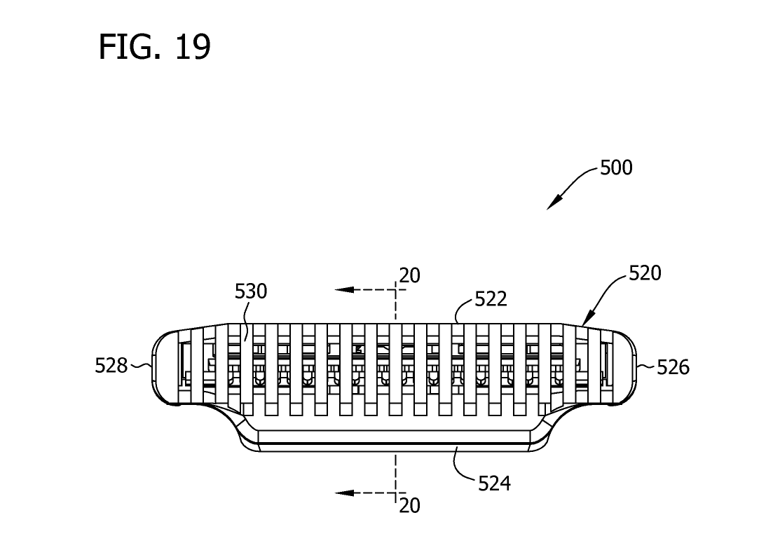

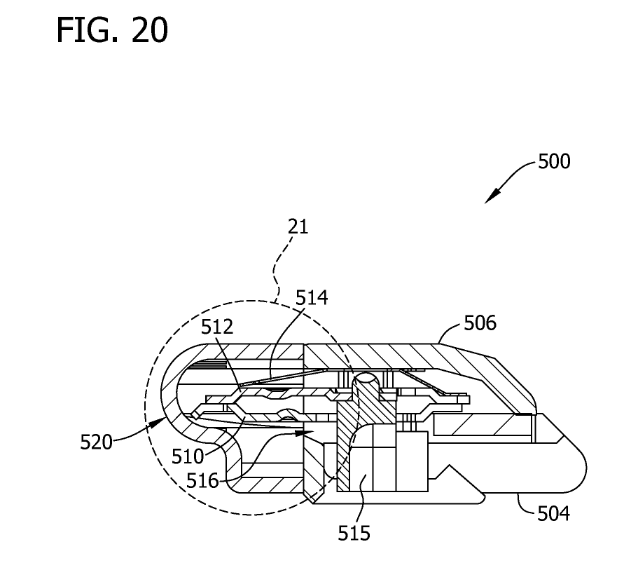

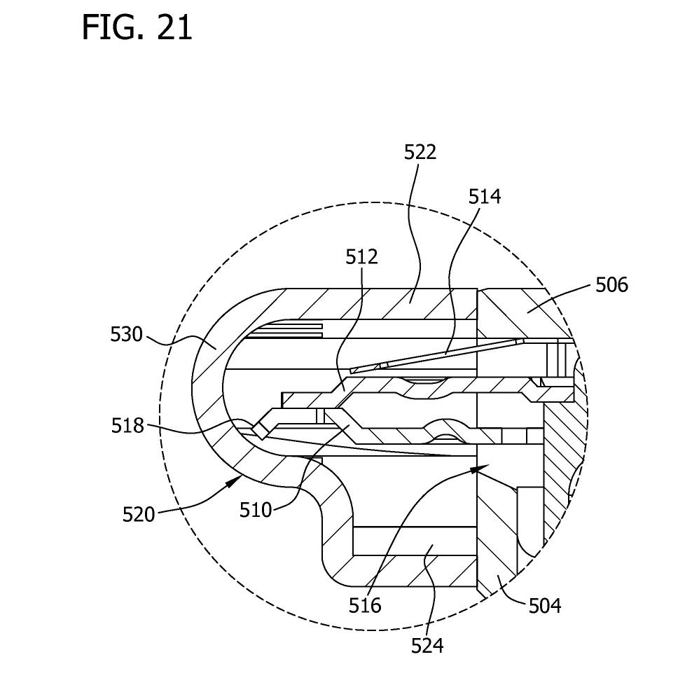

FIGS. 17-21 illustrate a third embodiment of a cutter head, generally indicated at 500, that is also similar to the cutter head 200 of FIGS. 1-11. Like the cutter head 200, the cutter head 500 comprises a housing 502 having a lower shell 504 and an upper shell 506 that house a cutting assembly 508. The shells 504, 506 define an elongate opening 516 from which a front edge 518 of the cutting assembly 508 extends for trimming hair. The cutting assembly 508 comprises a stationary blade 510 and a movable blade 512 biased against the stationary blade 510 via a suitable biasing member (e.g., a spring plate 514). The teeth of the blades 510, 512 extend outward through the opening 516 to define the front edge 518 of the cutting assembly 508, and a base 515 extends downward from the stationary blade 510 to facilitate releasable and operable connection of the cutter head 500 to the handle 102, as described above.

The housing 502 also comprises a guard cap 520 that includes an upper wall 522, a lower wall 524 opposite the upper wall 522, a first sidewall 526 extending between the upper and lower walls 522, 524, and a second sidewall 528 extending between the upper and lower walls 522, 524 opposite the first sidewall 526. A plurality of generally arcuate guard fingers 530 are integrally formed with and extend from the upper wall 522 to the lower wall 524 between the first sidewall 526 and the second sidewall 528. In the illustrated embodiment, the guard cap 520 (i.e., the walls 522, 524, 526, 528 and the guard fingers 530) is integrally formed from a synthetic or semi-synthetic, organic-based material (e.g., a “plastic” material) using a molding process. It is understood, however, that the guard cap 520 may be fabricated from any suitable material (e.g., a metallic material) using any suitable manufacturing process without departing from the scope of this invention.

In an assembled configuration of the cutter head 500, the guard cap 520 is detachably connected (e.g., via a snap-fit) to the lower shell 504 and the upper shell 506 over the front edge 518 of the cutting assembly 508 such that the guard fingers 530 are longitudinally spaced apart in relationship to one another and wrap over the front edge 518 along the elongate opening 516 to define a plurality of hair entry slots into which hair can enter during a trimming operation, while inhibiting skin from contacting the blades 510, 512. After use, the guard cap 520 can easily be detached from the lower shell 504 and the upper shell 506 (e.g., to be interchanged with another trimming tool, such as a differently sized guard cap, or to be cleaned). It is understood that the guard cap 520 may comprise any suitable number of guard fingers 530 having any suitable shape without departing from the scope of this invention. It is also understood that the spacing between adjacent guard fingers 530 may be other than as illustrated herein and remain within the scope of this invention.

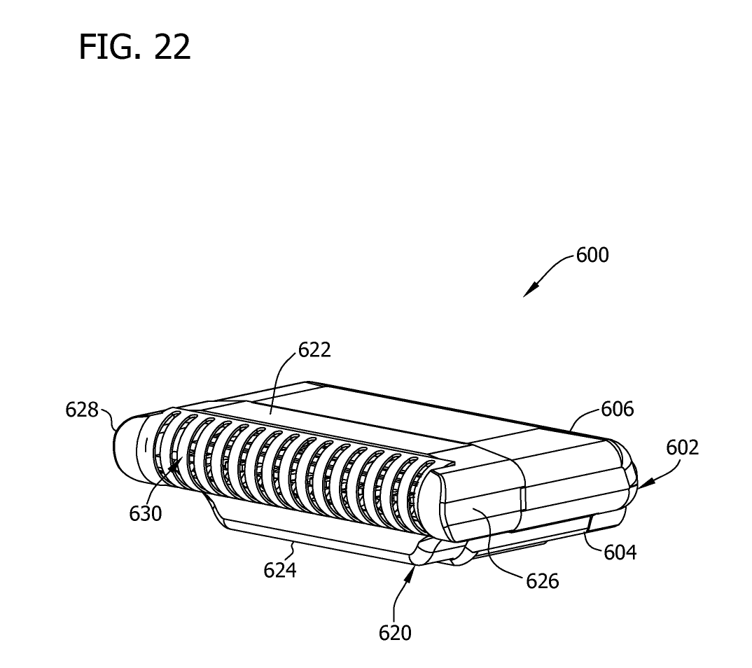

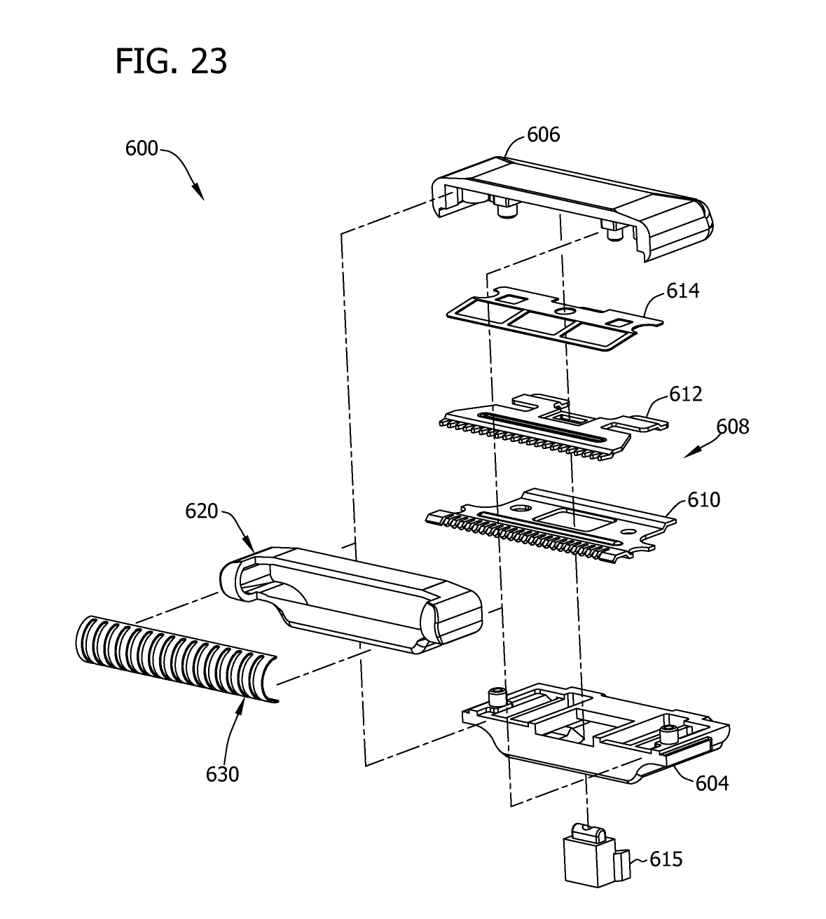

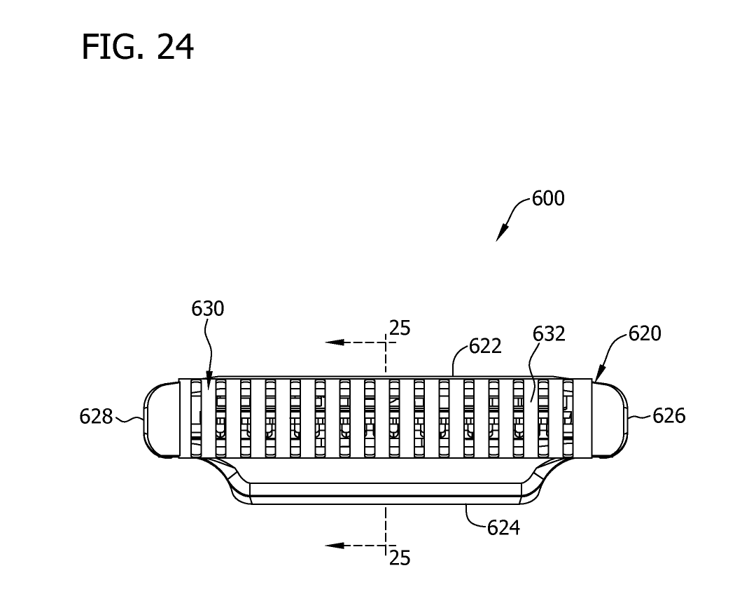

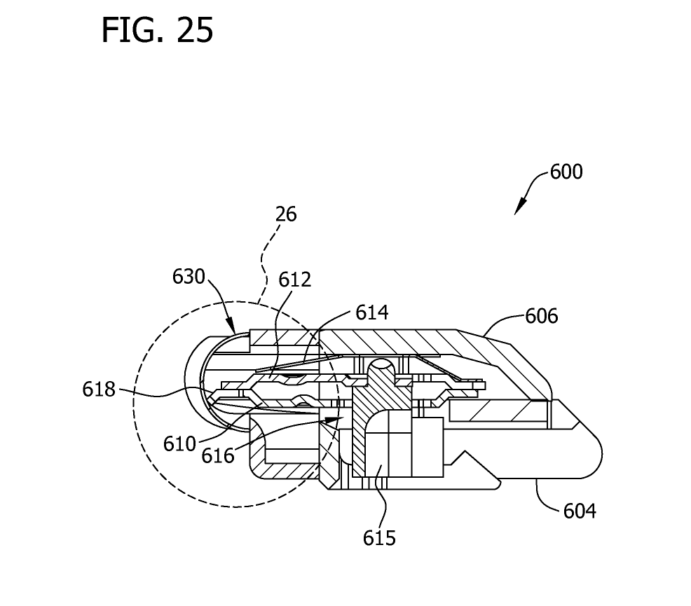

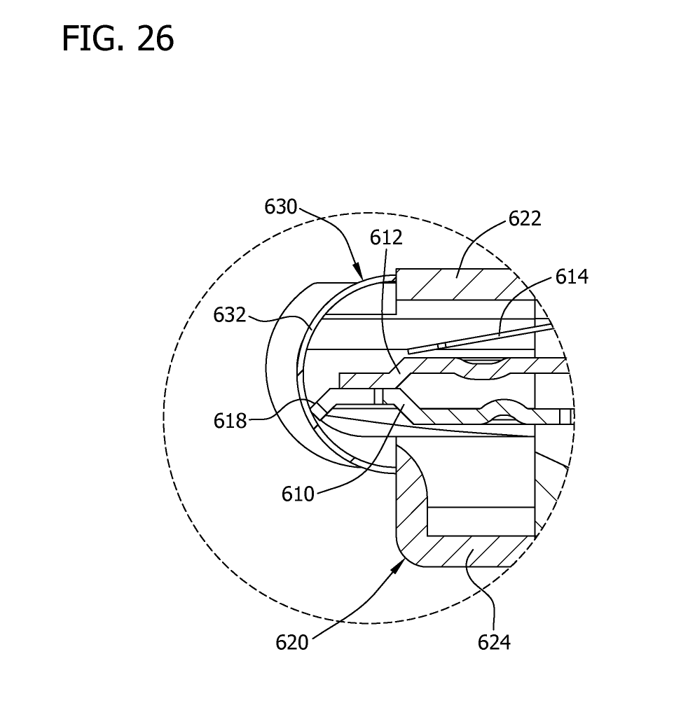

FIGS. 22-26 illustrate a fourth embodiment of a cutter head, generally indicated at 600, that is similar to the cutter head 500 of FIGS. 17-21. The cutter head 600 comprises a housing 602 having a lower shell 604 and an upper shell 606 that house a cutting assembly 608. The shells 604, 606 define an elongate opening 616 from which a front edge 618 of the cutting assembly 608 extends for trimming hair. The cutting assembly 608 comprises a stationary blade 610 and a movable blade 612, and the movable blade 612 is biased against the stationary blade 610 via a suitable biasing member (e.g., a spring plate 614). The teeth of the blades 610, 612 extend outward through the opening 616 to define the front edge 618 of the cutting assembly 608. Suitably, a base 615 extends downward from the stationary blade 610 to facilitate releasable and operable connection of the cutter head 600 to the handle 102, as described above.

The housing 602 also comprises a guard cap 620 that includes an upper wall 622, a lower wall 624 opposite the upper wall 622, a first sidewall 626 extending between the upper and lower walls 622, 624, and a second sidewall 628 extending between the upper and lower walls 622, 624 opposite the first sidewall 626. A guard member 630 is detachably connected to at least one of the upper wall 622, the lower wall 624, the first sidewall 626, and the second sidewall 628. The guard member 630 comprises a plurality of generally arcuate guard fingers 632 arranged to extend generally from the upper wall 622 to the lower wall 624 and are spaced apart from one another generally from the first sidewall 626 to the second sidewall 628 when the guard member 630 is connected to the guard cap 620.

In the illustrated embodiment, the guard cap 620 (i.e., the walls 622, 624, 626, 628) is integrally formed from a synthetic or semi-synthetic, organic-based material (e.g., a “plastic” material) using a molding process, while the guard member 630 is formed from a metallic material. It is understood, however, that the guard cap 620 and/or the guard member 630 may be fabricated from any suitable material using any suitable manufacturing process without departing from the scope of this invention.

In an assembled configuration of the cutter head 600, the guard cap 620 is detachably connected (e.g., via a snap-fit) to the lower shell 604 and the upper shell 606 over the front edge 618 of the cutting assembly 608 such that the guard fingers 632 are spaced longitudinally apart from one another and extend over the front edge 618 along the elongate opening 616 to define a plurality of hair entry slots into which hair can enter during a trimming operation, thereby inhibiting skin from contacting the blades 610, 612. After use, the guard cap 620 can be detached from the lower and upper shells 604, 606 (e.g., to be interchanged with another trimming tool, such as a different sized guard cap, or to be cleaned). Additionally, the guard member 630 can easily be detached from the guard cap 620 for similar reasons. It is understood, however, that the guard member 630 may comprise any suitable number of guard fingers 632 having any suitable shape without departing from the scope of this invention. It is also understood that the spacing between adjacent guard fingers 632 may be other than as illustrated herein and remain with the scope of this invention.

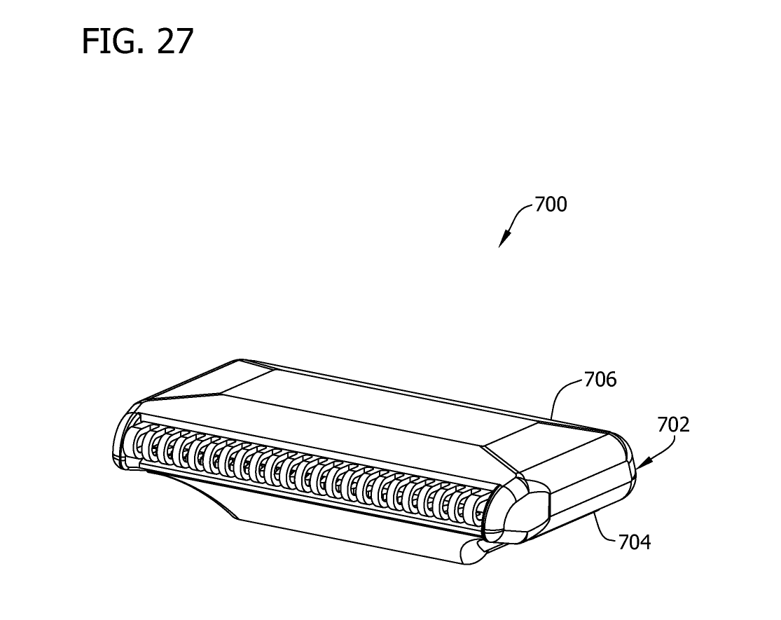

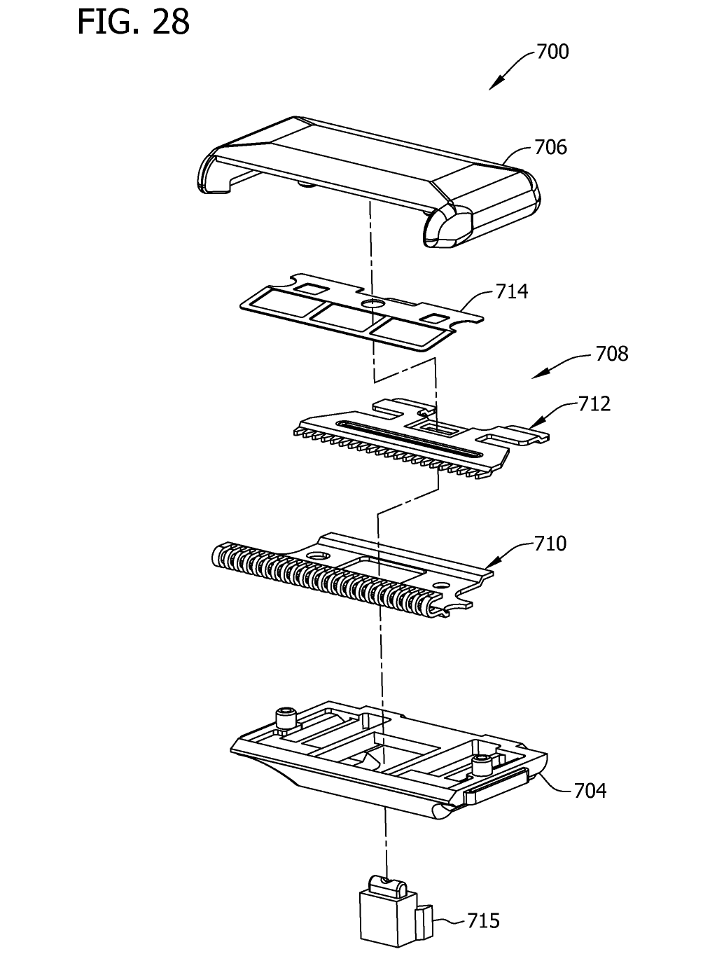

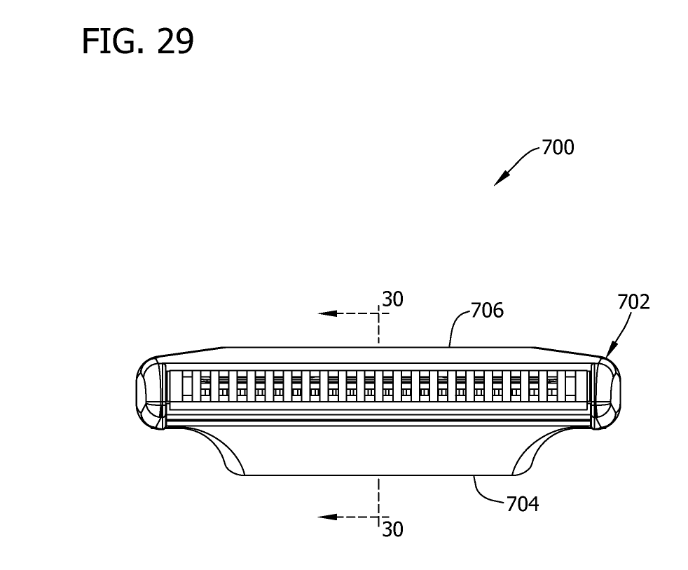

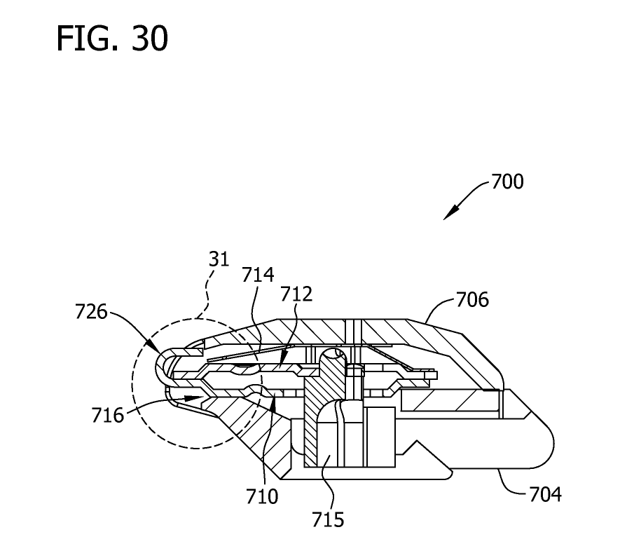

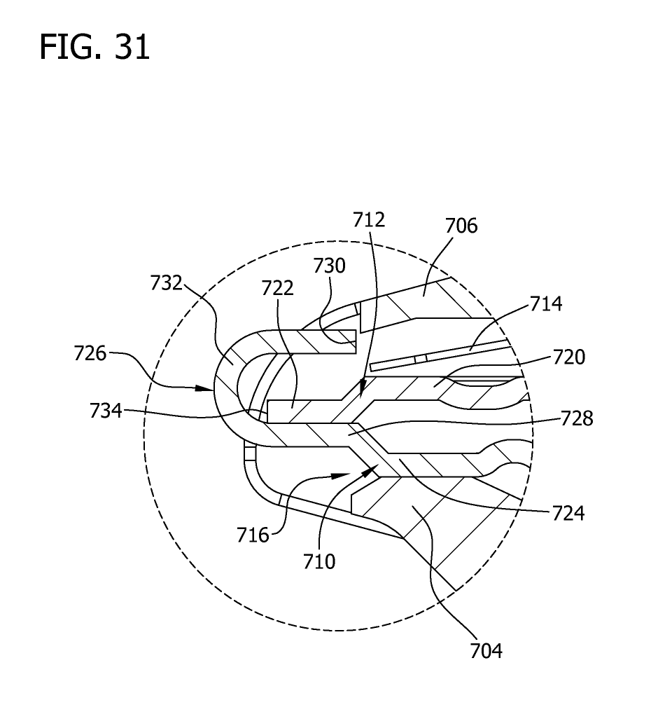

FIGS. 27-31 illustrate a fifth embodiment of a cutter head, generally indicated at 700, that is similar to the cutter heads described above. The cutter head 700 comprises a housing 702 including a lower shell 704 and an upper shell 706 that house a cutting assembly 708. The shells 704, 706 define an elongate opening 716 from which the cutting assembly 708 extends for trimming hair. The cutting assembly 708 comprises a stationary blade 710 and a movable blade 712 biased into sliding, face-to-face contact with the stationary blade 710 via a biasing member (e.g., a spring plate 714). Suitably, a base 715 extends downward from the stationary blade 710 to facilitate releasable and operable connection of the cutter head 700 to the handle 102 in a manner similar to that described above.

The movable blade 712 comprises base plate 720 and a plurality of teeth 722 integrally formed with and extending from the base plate 720, and the stationary blade 710 comprises a base plate 724 and a guard member 726 integrally formed with and extending from the base plate 724. The guard member 726 comprises a bottom edge 728, a top edge 730, and a plurality of guard fingers 732 that extend from the bottom edge 728 to the top edge 730. The guard fingers 732 are spaced apart from one another along the elongate opening 716 to define a plurality of hair entry slots into which hair can enter during a trimming operation. The stationary blade 710 (i.e., the base plate 724 and the guard member 726) are suitably fabricated from metallic material using stamping and bending processes. It is understood, however, that the movable blade 712 and/or the stationary blade 710 may be fabricated from any suitable material using any suitable manufacturing processes without departing from the scope of this invention.

During operation, the movable blade 712 is biased into sliding, face-to-face contact against the bottom edge 728 and at least a portion of the guard fingers 732 of the guard member 726 via the spring plate 714 such that the teeth 722 of the movable blade 712 slide against the guard member 726 to trim hair that enters the slots and such that the guard fingers 732 extend over a front edge 734 of the movable blade 712 to inhibit skin from contacting the movable blade 712. It is understood, however, that the movable blade 712 could be configured to slide against any suitable portion of the guard member 726 without departing from the scope of this invention.

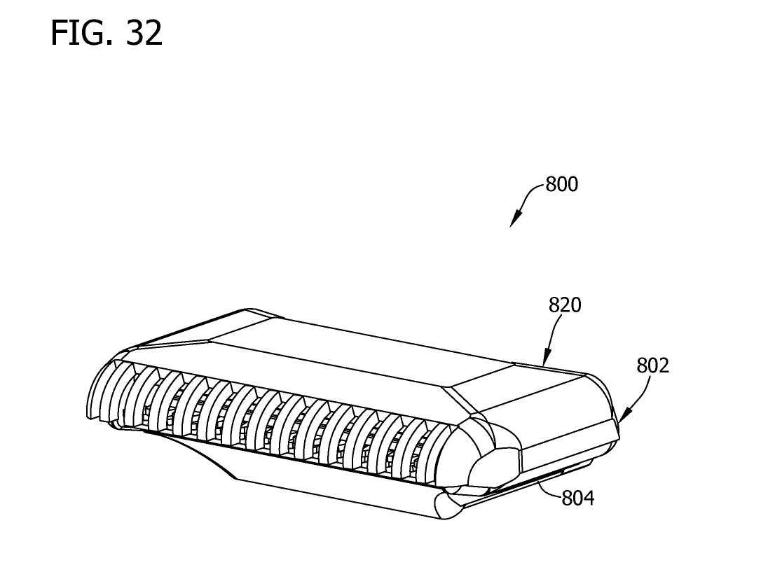

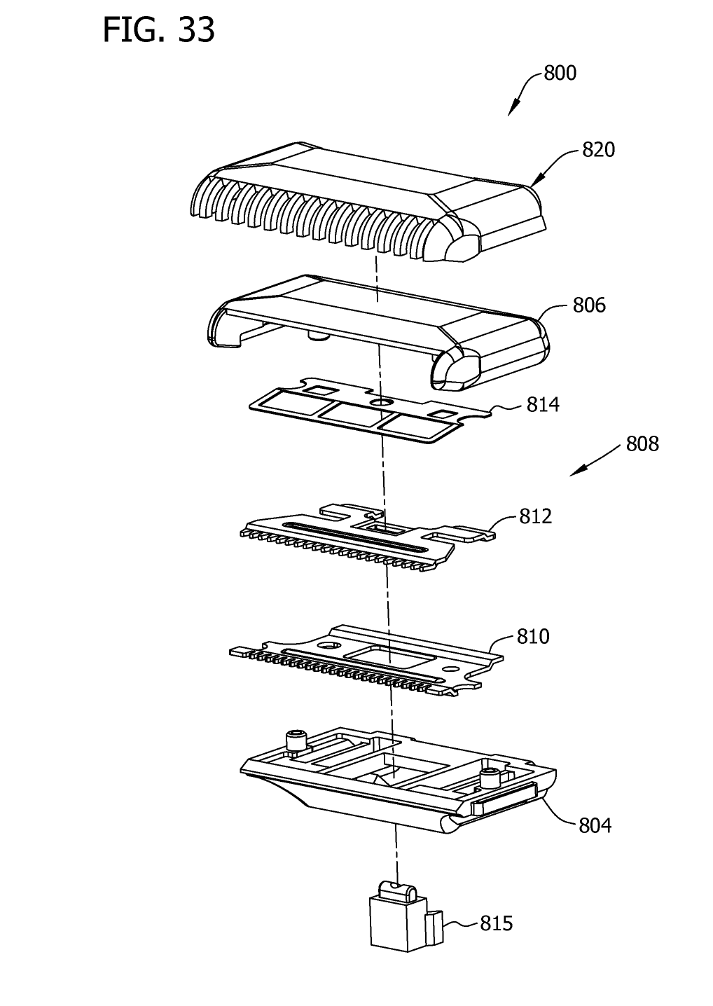

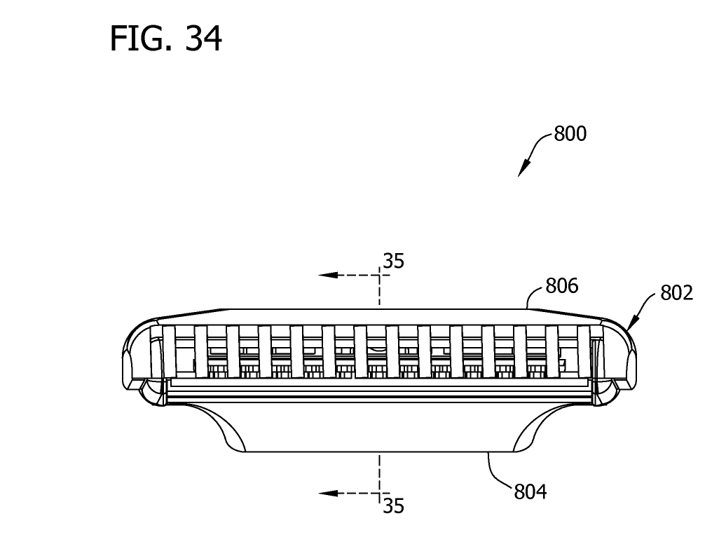

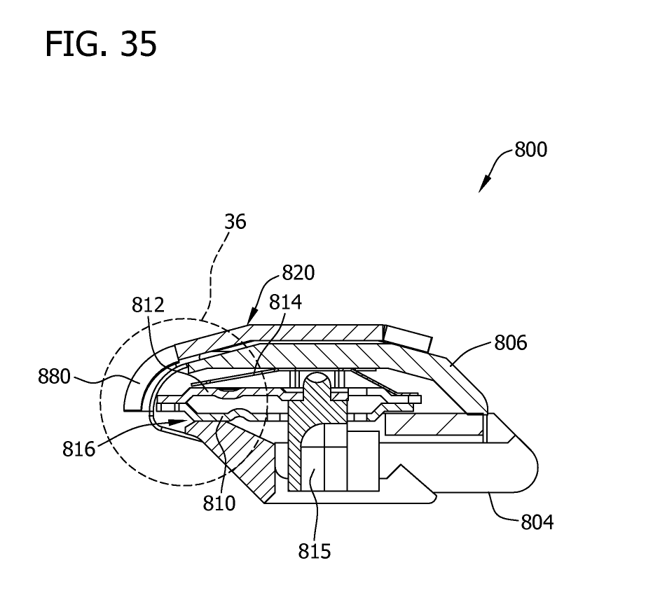

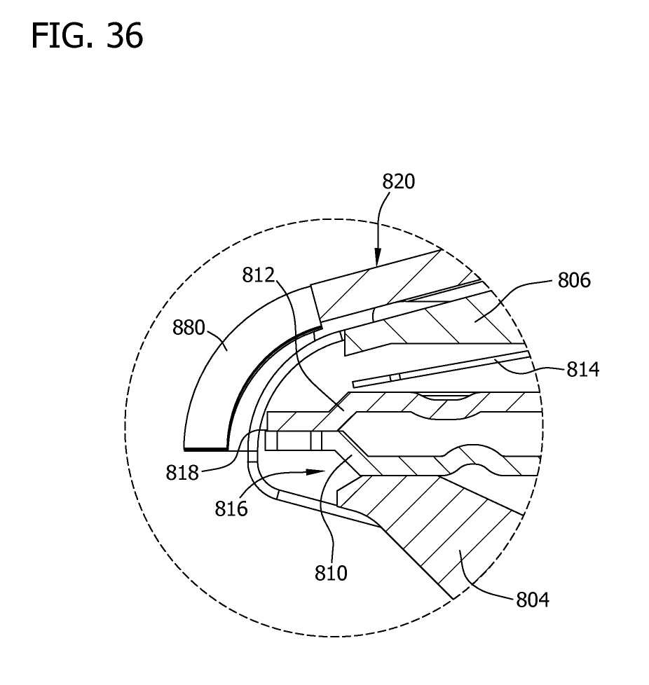

FIGS. 32-36 illustrate a sixth embodiment of a cutter head, generally indicated at 800, that is similar to the cutter head 200. The cutter head 800 suitably comprises a housing 802 including a lower shell 804 and an upper shell 806 that house a cutting assembly 808. The shells 804, 806 define an elongate opening 816 from which a front edge 818 of the cutting assembly 808 extends for trimming hair. The cutting assembly 808 comprises a stationary blade 810 and a movable blade 812 that is biased in sliding, face-to-face contact against the stationary blade 810 via a suitable biasing member (e.g., a spring plate 814). The teeth of each of the blades 810, 812 extend outward through the opening 816 of the housing 802 to collectively define the front edge 818 of the cutting assembly 808. The cutting assembly 808 also comprises a base 815 that extends downward from the stationary blade 810 to facilitate releasable and operable connection of the cutter head 800 to the handle 102, as described above.

The housing 802 also comprises a cover 820 that is detachably connected to the upper shell 806 such that the cover 820 substantially covers the top surfaces of the upper shell 806. The cover 820 comprises a plurality of upper guard fingers 880 that extend from a proximal end formed integral with the cover 820 to a distal end that is slightly beyond the front edge 818 in an arcuate orientation such that the guard fingers 880 extend in a spaced apart relationship with one another along the elongate opening 816. The upper guard fingers 880 of the cover 820 also extend generally downward and at least in part over the front edge 818 of the cutting assembly 808 to facilitate inhibiting skin from contacting the front edge 818 during trimming.

Because the cover 820 is detachably connected to the upper shell 806, a user can easily remove the cover 820 (e.g., to interchange the cover 820 with another cover, such as a cover having upper guard fingers of a different length, spacing, and/or contour, or to clean the cover 820 or the cutting assembly 808). It is understood that the cover 820 may comprise any suitable number of guard fingers 880 having any suitable overall shape without departing from the scope of this invention. It is also understood that the spacing between adjacent the guard fingers 880 may be other than as illustrated herein and remain with the scope of this invention.

It should be noted that the movable and/or stationary blades described herein may suitably be fabricated from a ceramic material, or from a metallic material that is at least partially coated in a synthetic or semi-synthetic, organic-based polymer (e.g., polytetrafluoroethylene (PTFE)). It should also be noted that any one embodiment of the cutter heads illustrated in FIGS. 1-36 may suitably comprise features of the other embodiments of cutter heads illustrated in FIGS. 1-36 without departing from the scope of the invention describe herein.

When introducing elements of the present invention or the preferred embodiment(s) thereof, the articles “a”, “an”, “the”, and “said” are intended to mean that there are one or more of the elements. The terms “comprising,” “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An electric hair trimmer comprising:
a handle housing a drive motor; and
a cutter head releasably connectable to the handle, the cutter head comprising:
a housing having an interior compartment; and
a cutting assembly comprising a pair of cutting blades, at least one of the cutting blades being in operative connection with the drive motor upon connection of the cutter head with the handle for reciprocating movement of said at least one of the blades, at least a portion of the cutting assembly being disposed within the housing, the cutting assembly further having a front edge disposed exterior of the housing for trimming hair upon operation of the trimmer,
the housing having a plurality of guard fingers at least in part wrapped over the front edge of the cutting assembly to inhibit the front edge against contacting a person's skin during hair trimming.

2. The electric hair trimmer set forth in claim 1 wherein the cutter head housing has an elongate opening therein through which the cutting assembly extends such that the front edge is disposed exterior of the housing, the plurality of guard fingers extending outward from the housing in spaced relationship with each other generally along the elongate opening of the housing.

3. The electric hair trimmer set forth in claim 1 wherein each of the guard fingers comprises a first segment extending at least in part outward from the housing one of above and below the cutting assembly, and a second segment extending from the first segment at an angle relative thereto such that the second segment at least in part extends over the front edge of the cutting assembly.

4. The electric hair trimmer set forth in claim 3 wherein the second segment extends generally at a perpendicular angle relative to the first segment such that the finger is generally L-shaped.

5. The electric hair trimmer set forth in claim 3 wherein the first segment extends generally parallel to the cutting blades.

6. The electric hair trimmer set forth in claim 3 wherein the first segment extends from the housing at an angle relative to the cutting blades.

7. The electric hair trimmer set forth in claim 3 wherein at least one of the guard fingers extends above the cutting assembly and downward over the front edge thereof and at least one other one of the guard fingers extends below the cutting assembly and upward over the front edge thereof.

8. The electric hair trimmer set forth in claim 7 wherein a plurality of the guard fingers extends above the cutting assembly and downward over the front edge thereof and a different plurality of the guard fingers extends below the cutting assembly and upward over the front edge thereof, the plurality of the guard fingers and the different plurality of the guard fingers being intersticed over the front edge of the cutting assembly.

9. The electric hair trimmer set forth in claim 7 wherein said at least one of the guard fingers is configured differently from said at least one other one of the guard fingers.

10. The electric hair trimmer set forth in claim 1 wherein the housing comprises an upper shell and a lower shell configured for assembly to define an interior compartment of the housing for housing a portion of the cutting assembly, and an elongate opening through which another portion of the cutting assembly including the front edge thereof extend exterior of the housing.

11. The electric hair trimmer set forth in claim 10 wherein all of said plurality of guard fingers extend outward from the upper shell of the housing.

12. The electric hair trimmer set forth in claim 10 wherein the housing comprises a cover detachably connected to the upper shell, all of said plurality of guard fingers extending from the cover.

13. The electric hair trimmer set forth in claim 10 wherein all of said plurality of guard fingers extend outward from the lower shell of the housing.

14. A cutter head for an electric hair trimmer, the cutter head comprising:
a housing having an interior compartment; and
a cutting assembly comprising a pair of cutting blades, at least one of the cutting blades being configured for reciprocating movement, at least a portion of the cutting assembly being disposed within the housing, the cutting assembly further having a front edge disposed exterior of the housing for trimming hair upon operation of the trimmer,
the housing having a plurality of guard fingers at least in part wrapped over the front edge of the cutting assembly to inhibit the front edge against contacting a person's skin during hair trimming.

15. The cutter head set forth in claim 14 wherein the cutter head housing has an elongate opening therein through which the cutting assembly extends such that the front edge is disposed exterior of the housing, the plurality of guard fingers extending outward from the housing in spaced relationship with each other generally along the elongate opening of the housing.

16. The cutter head set forth in claim 14 wherein each of the guard fingers comprises a first segment extending at least in part outward from the housing one of above and below the cutting assembly, and a second segment extending from the first segment at an angle relative thereto such that the second segment at least in part extends over the front edge of the cutting assembly.

17. The cutter head set forth in claim 16 wherein the second segment extends generally at a perpendicular angle relative to the first segment such that the finger is generally L-shaped.

18. The cutter head set forth in claim 16 wherein the first segment extends generally parallel to the cutting blades.

19. The cutter head set forth in claim 16 wherein the first segment extends from the housing at an angle relative to the cutting blades.

20. The cutter head set forth in claim 16 wherein at least one of the guard fingers extends above the cutting assembly and downward over the front edge thereof and at least one other one of the guard fingers extends below the cutting assembly and upward over the front edge thereof.

21. The cutter head set forth in claim 20 wherein a plurality of the guard fingers extends above the cutting assembly and downward over the front edge thereof and a different plurality of the guard fingers extends below the cutting assembly and upward over the front edge thereof, the plurality of the guard fingers and the different plurality of the guard fingers being intersticed over the front edge of the cutting assembly.

22. The cutter head set forth in claim 20 wherein said at least one of the guard fingers is configured differently from said at least one other one of the guard fingers.

23. The cutter head set forth in claim 14 wherein the housing comprises an upper shell and a lower shell configured for assembly to define an interior compartment of the housing for housing a portion of the cutting assembly, and an elongate opening through which another portion of the cutting assembly including the front edge thereof extends exterior of the housing.

24. The cutter head set forth in claim 23 wherein all of said plurality of guard fingers extend outward from the upper shell of the housing.

25. The cutter head set forth in claim 23 wherein the housing comprises a cover detachably connected to the upper shell, all of said plurality of guard fingers extending from the cover.

26. The cutter head set forth in claim 23 wherein all of said plurality of guard fingers extend outward from the lower shell of the housing.

27. An electric hair trimmer comprising:
a handle housing a drive motor; and
a cutter head releasably connectable to the handle, the cutter head comprising:
a housing having an interior compartment; and
a cutting assembly comprising a pair of cutting blades, at least one of the cutting blades being in operative connection with the drive motor upon connection of the cutter head with the handle for reciprocating movement of said at least one of the blades, at least a portion of the cutting assembly being disposed within the housing, the cutting assembly further having a front edge disposed exterior of the housing for trimming hair upon operation of the trimmer,
the housing having a cutter guard extending over a portion of the front edge of the cutting assembly to inhibit the front edge against contacting a person's skin during hair trimming.

28. A cutter head for an electric trimmer, the cutter head comprising:
a housing having an interior compartment; and
a cutting assembly comprising a pair of cutting blades, at least one of the cutting blades being in operative connection with the drive motor upon connection of the cutter head with the handle for reciprocating movement of said at least one of the blades, at least a portion of the cutting assembly being disposed within the housing, the cutting assembly further having a front edge disposed exterior of the housing for trimming hair upon operation of the trimmer,
said housing comprising a plurality of guard fingers extending beyond but not over the front edge of the cutting assembly to inhibit the front edge against contacting a person's skin during hair trimming.

29. The cutter head set forth in claim 28 wherein the housing comprises an upper shell and a lower shell configured for assembly to define the interior compartment for housing the at least a portion of the cutting assembly.

30. The cutter head set forth in claim 29 wherein the upper shell and the lower shell when assembled define an elongate opening through which the cutting assembly extends such that the front edge is disposed exterior of the housing, the plurality of guard fingers extending outward from the housing in spaced relationship with each other along the elongate opening of the housing.

31. The cutter head set forth in claim 30 wherein each of the guard fingers has an overall linear shape.

32. The cutter head set forth in claim 31 wherein a plurality of said guard fingers extends above the cutting assembly at an oblique angle relative to the blades and a different plurality of said guard fingers extends below the cutting assembly substantially parallel to the blades, said plurality of said guard fingers and said different plurality of said guard fingers being intersticed along the elongate opening.

33. A cutter head for an electric trimmer, the cutter head comprising:
a housing having an interior compartment; and
a cutting assembly comprising a pair of cutting blades, at least one of the cutting blades being in operative connection with the drive motor upon connection of the cutter head with the handle for reciprocating movement of said at least one of the blades, at least a portion of the cutting assembly being disposed within the housing, the cutting assembly further having a front edge disposed exterior of the housing for trimming hair upon operation of the trimmer,
said housing comprising a plurality of acruately shaped guard fingers wrapped over the front edge of the cutting assembly to inhibit the front edge against contacting a person's skin during hair trimming.

34. The cutter head set forth in claim 33 wherein the housing comprises an upper shell and a lower shell defining the interior compartment that houses the at least a portion of the cutting assembly.

35. The cutter head set forth in claim 34 wherein the upper shell and the lower shell define an elongate opening through which the cutting assembly extends such that the front edge is disposed exterior of the interior compartment, the plurality of guard fingers arranged in spaced relationship with each other along the elongate opening of the housing.

36. The cutter head set forth in claim 35 wherein the housing comprises a guard cap detachably connected to at least one of the upper shell and the lower shell, the guard cap comprising the plurality of guard fingers.

37. The cutter head set forth in claim 36 wherein the guard cap comprises an upper wall, a lower wall, a pair of opposing sidewalls extending between the upper and lower walls, and a guard member detachably connected to at least one of the upper wall, the lower wall, and the pair of opposing sidewalls, wherein the guard member comprises the plurality of guard fingers.

38. The cutter head set forth in claim 37 wherein the upper wall, the lower wall, and the pair of opposing sidewalls are integrally formed from a plastic material, the guard member being formed from a metallic material.

39. The cutter head set forth in claim 33 wherein the cutting blades comprise a movable blade having a plurality of teeth and a stationary blade having the plurality of guard fingers, the movable blade biased in face-to-face contact with the stationary blade such that the teeth are slidable against the stationary blade with the plurality of guard fingers wrapped over at least a portion of the teeth to inhibit the teeth against contacting a person's skin during hair trimming.

40. A cutter head for an electric trimmer, the cutter head comprising:
a stationary blade having a plurality of guard fingers; and
a movable blade having a plurality of teeth, the movable blade being biased in face-to-face contact with the stationary blade such that the teeth are slidable against the stationary blade with the plurality of guard fingers of said stationary blade wrapped over at least a portion of the teeth of said movable blade to inhibit said teeth against contacting a person's skin during hair trimming.
